(19) United States
(12) Patent Application Publication
(10) Pub. No.: US 2007/0042237 A1
(43) Pub. Date: Feb. 22, 2007

(54) Mixed reactant fuel cell system with vapor recovery and method of recovering vapor

(75) Inventors: Moisey Sorkin, Princeton, NJ (US); H. Frank Gibbard, Epping, NH (US); Arthur Kaufman, West Orange, NJ (US)

Correspondence Address: BURNS & LEVINSON, LLP;(FORMERLY PERKINS SMITH & COHEN LLP), 125 SUMMER STREET, BOSTON, MA, 02110, US

(73) Assignee: Gibbard Research & Development Corp., Haverhill, MA (US)

(21) Appl. No.: 11/506,695

(22) Filed: Aug. 18, 2006

Related U.S. Application Data
(60) Provisional application No. 60/709,680, filed on Aug. 19, 2005.

(51) Int. Cl. H01M 8/04

(52) U.S. Cl. 429/17; 429/26

(57) ABSTRACT

The invention is a mixed-reactant fuel cell system with vapor recovery and methods of recovering vapor and generating electrochemical power.

### RELATED APPLICATIONS

This application claims priority of provisional application No. 60/709,680, entitled “Mixed Reactant Direct Methanol Fuel Cell System”, filed Aug. 19, 2005, the entire contents of which are incorporated herein.

### BACKGROUND

A fuel cell consists of two electrodes sandwiched around an electrolyte which keeps the chemical reactants physically separated from each other. In the most common type of fuel cell the reactants are hydrogen and oxygen. Oxygen passes over one electrode (cathode) and hydrogen over the other (anode), generating electricity, water and heat.

A direct methanol fuel cell is widely applicable in distributed power generation or as a portable power supply, since, in this fuel cell, liquid methanol is directly utilized for power generation without the need of storing hydrogen or producing hydrogen on site by reforming liquid hydrocarbons. The absence of the requirement for hydrogen storage and transportation or bulky and complicated fuel processors for hydrogen production can potentially lead to a small, lightweight power source

A direct methanol fuel cell contains: (i) a proton conducting solid electrolyte film; (ii) an anode layer and a cathode layer provided on both surfaces of the proton conducting solid electrolyte film, in which each of the anode and the cathode layers are produced by applying a suitably formulated catalyst on anode and cathode sides of the membrane or on a reactant diffusion layer; (iii) the diffusion or reactant distribution layer is usually a porous carbon paper or carbon cloth appropriately treated to achieve required level of hydrophobicity or hydrophilicity; (iv) an anode side separator having grooves to supply an aqueous solution of methanol as a fuel; and (v) a cathode side separator having grooves to supply air as an oxidizing gas. When an aqueous solution of methanol is supplied to the anode and air is supplied to the cathode, methanol enters into an electrocatalytic oxidation reaction with water producing protons, electrons and gaseous carbon dioxide:
CH₃OH+H₂O→CO₂+6H⁺+6e⁻
Protons migrate through the electrolyte and, together with electrons supplied by the anodic reaction, react with the air's oxygen reducing oxygen to water:
6H⁺+3/2O₂+6e⁻→3H₂O
with the net electrochemical overall reaction of
CH₃OH+3/2O₂→CO₂+2H₂O
The reactions result in a sustained electric potential difference between anode and cathode allowing for electric power generation.

The main disadvantages of a direct methanol fuel cell are lower efficiency and higher capital cost per unit of delivered power as compared to other types of fuel cells. The full commercial potential of direct methanol fuel cells is not realized in commercial applications such as, for example, portable fuel cell systems, because of the size and cost of the fuel cell plant (system). Due to less efficient electrochemical conversion, the size of the fuel cell stack (individual fuel cells are assembled into a stack where the cells are connected in series electrically and in parallel in respect to reactant flows) in direct methanol cells is bigger and heavier than, for example, a hydrogen/oxygen fuel cell stack with the same power output. Although the direct methanol system does not require a fuel processor or bulky hydrogen storage, the requirements for efficiency and high energy density demand high utilization of methanol. This demand complicates the design of the balance of the plant by adding the need for a means to recover and recycle un-reacted methanol.

An alternative approach called a mixed-reactant fuel cell has been introduced as a possible solution to achieve a compact, lightweight design of direct methanol fuel cell system. A description of this approach can be found in US Patent Applications 2003/0165727 and 2004/0058203 and in Simplified Direct Methanol Fuel Cell Using Mixed-Reactants, V. Hovland, J. L. Martin, M. Priestnall, Fuel Cell Seminar 2004, the entire contents of which are expressly incorporated herein. A mixed-reactant feed approach in regard to a direct methanol fuel cell includes mixing liquid methanol to produce a two-phase liquid-gaseous mixture or one-phase gas-vapor mixture and feeding this mixture into or over both anode and cathode electrodes.

The mixed-reactant fuel cell system described in Simplified Direct Methanol Fuel Cell Using Mixed-Reactants, V. Hovland, J. L. Martin, M. Priestnall, Fuel Cell Seminar 2004 is a one-pass system, where the reactant stream after passing through the fuel cell stack is exhausted. There is no recovery means to collect and recycle the unused methanol. That system can be utilized with a simplified balance of plant. The disadvantage of such approach is that for normal operation the amount of reactants passing over or through the electrodes has to be several times higher than the amount needed to sustain the reaction (stoichiometric value). The ratio of reactant required to pass to the stoichiometric value (stoichiometric ratio) depends on the structure of the catalytic layer, catalyst effectiveness and number of other factors and in a direct methanol fuel cell is usually in the range of 3-6 for air and 4-6 for methanol/water solution. The one-pass system therefore requires very high utilization of methanol, that is hardly achievable with existing catalysts, or it will have a very low efficiency and energy density due to the high consumption of methanol and water.

### SUMMARY OF THE INVENTION

In one embodiment the invention is a fuel cell system comprising a mixed-reactant fuel cell stack; a mass/enthalpy exchange module; a means for delivering oxidant; a reservoir for liquid fuel; a means for introducing fuel into a mixed-reactant flow; the mass/enthalpy exchange module or vapor exchange module (these terms may be used interchangeably throughout the application) is located downstream of the stack and upstream of the fuel injection point and has separate inlets receiving the flow exiting the fuel cell stack and fresh incoming oxidant flow from the oxidant delivery means.

In the system, the mass/enthalpy exchange module recycles un-reacted fuel, water and heat from the stack exhaust to incoming fresh oxidant.

In one aspect of the invention, the mass/enthalpy exchange module is a membrane vapor exchange device. The membrane can be a non-porous membrane permeable to water and methanol. The device can also be comprised of multiple membranes. Non-porous membranes can also be comprised of a non-porous layer supported by a porous membrane substrate. Hollow fiber materials are another example of membrane materials. A plurality of membranes or fiber materials can be used in the device.

In one aspect of the invention, the fuel in the reservoir is methanol, undiluted with other fuels or liquids. Alternatively, the fuel is a methanol/water solution, preferred but not limited to a solution of molar concentration in the range of 6-30. The fuel system of the invention can use air or oxygen as the oxidant.

The mass/enthalpy exchange module effects the transfer of methanol, water and heat by passing the flow exiting the fuel cell stack in one direction on one side of the vapor exchange membrane and passing fresh oxidant flow in the opposite direction on the opposite side of the membrane.

In one aspect of the invention, the vapor exchange membrane is sandwiched between two flow plates having passages for passing gaseous flows over the membrane. The passages can be made of various configurations such as being designed as curved channels, zigzag channels, serpentine channels, straight channels, or the like.

In another aspect of the invention, the vapor exchange module is comprised of a bundle of micro-tubes made of suitable membrane material and enclosed in a non-porous casing. The design of the module allows for the passage of one gaseous flow inside the micro-tubes and for the passage of the second flow outside the tubes with the transfer of un-reacted fuel, water and heat occurring through the tubing wall.

In an embodiment of the invention, the stack operational temperature is maintained approximately at or above the temperature of transition to the vapor phase for the multi-component feed (i.e. oxidant and fuel) entering the stack.

In some embodiments of the invention, additional components are included such as a mixer or an atomizer; additional liquid storage reservoirs; additional means for delivery of liquids; air and fuel filters; and methanol concentration sensors. The fuel cell system can also include a power conversion system; system controllers; and safety and process conditions sensors.

In one embodiment the invention is a method of recycling or reclaiming unused or unreacted mixed-reactant fuel by recovering fuel and water from the exhaust exiting a fuel cell stack. The method comprises passing an oxidant and fuel cell stack exhaust through a mass/enthalpy exchange module where un-reacted fuel, water and heat in the fuel cell stack exhaust flow stream are transferred to the oxidant flow steam thereby producing recycled mixed-reactant fuel.

In another embodiment the invention is a method of generating electrochemical power using recycled mixed-reactant fuel. The method comprises adding liquid fuel to recycled mixed-reactant fuel to produce a reconstituted mixed-reactant fuel, which is passed over or through a mixed-reactant fuel cell stack in order to produce or generate electrochemical energy.

The ways of and conditions for building and operating the system and performing the methods of the invention will be explained further in the accompanying drawings and detailed description.

### BRIEF DESCRIPTION OF THE DRAWINGS

FIG. 1 is a schematic diagram of a direct methanol fuel cell system for purpose of illustrating the level of system complexity;

FIG. 2 is a schematic diagram for a one-pass mixed-reactant system that is characterized by low fuel efficiency;

FIG. 3 is a schematic diagram of a mixed-reactant fuel cell system with conventional fuel recovery for purpose of illustrating the level of system complexity;

FIG. 4 is a schematic diagram of a recycling mixed-reactant fuel cell system with vapor recovery according to the invention;

FIG. 5 is a schematic diagram of the working principle of a membrane vapor exchange module;

FIG. 6 is an exploded pictorial view of a “flat-plate” or “sheet type” membrane exchange module;

FIG. 7 is a schematic diagram of the component mass flows in an example of an embodiment of the invention that depicts conditions in a mixed-reactant system operating at 25 W; and

FIG. 8 is a graph of the temperatures of the liquid-plus-vapor to vapor transition versus methanol to methanol/water molar ratios in methanol/water solutions at the equilibrium partial pressures above solutions of various compositions.

### DETAILED DESRIPTION

To better understand the present invention, the terms “fuel cell” and “Fuel Cell System” as used herein are defined. “Fuel cell” denotes a power generating electrochemical device to which reactants (fuel and oxidant) are fed to sustain an oxidation-reduction reaction that produces an electric potential difference on its anode and cathode terminals. “Fuel Cell System” denotes a power generating plant that includes fuel cell, and other components to sustain fuel cell operation and means of controlling fuel cell system operation and means of conditioning fuel cell energy output.

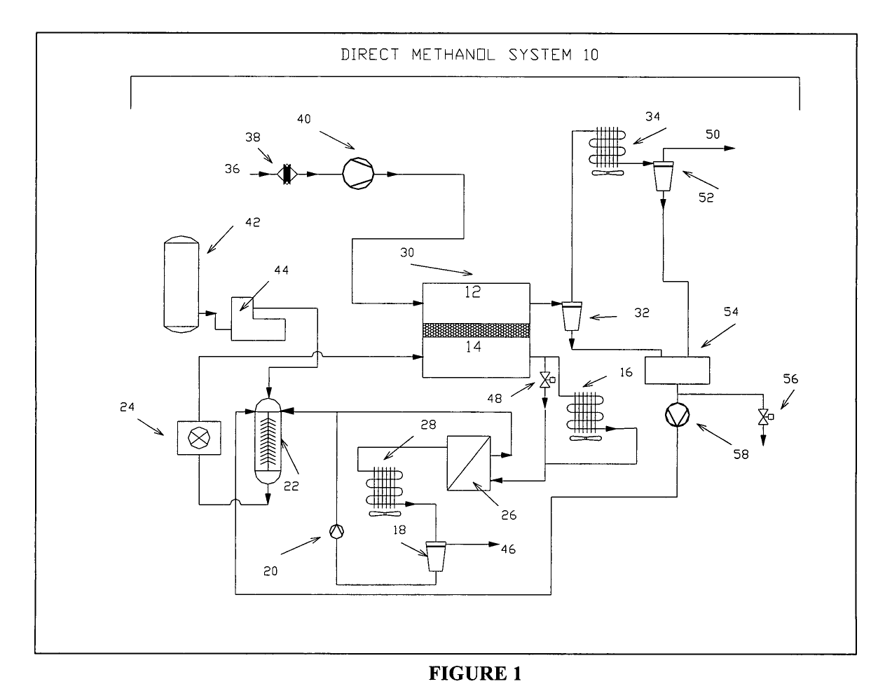

In a direct methanol system 10 as depicted in FIG. 1, the oxidant (air or oxygen) is brought in contact with the cathode electrode 12 and fuel (liquid methanol/water solution usually of 0.5-2M methanol concentration) is brought in contact with the anode electrode 14. In order to utilize the fuel to the maximum extent, the fuel flow exiting the anode flow path flows through a radiator 16 to lower its temperature and into a collecting tank 18. It is passed through a recycling pump 20 and into a mixer 22 where neat methanol is added to the solution to maintain the desired methanol concentration as monitored by a methanol concentration sensor 24. The gaseous phase of the anode flow, containing carbon dioxide and methanol/water vapor is separated from the liquid phase in a gas-liquid separator 26 and passed through another radiator/condenser 28, where methanol vapor and partially the water vapor are condensed into liquid; the liquid is collected and directed into the collecting tank 18. The cathode flow exiting the fuel cell stack 30 contains liquid methanol and methanol vapor as well as liquid water and water vapor due to sufficient methanol/water crossover from the anode side. The liquid, exiting the cathode flow path, is collected and directed into a collecting tank 32 while the gaseous phase of the cathode flow is separated from the liquid phase and passed through a separate radiator/condenser 34, where the methanol and part of the water vapor is condensed into liquid, the liquid is collected and pumped into the collecting tank 52, from where it is directed into tank 54 and eventually pumped into mixer 22. The direct methanol system 10 also includes an air inlet 36, air filters 38 and an air pump 40 for introducing oxidant into the system 10, and a fuel storage tank 42, and a metering pump 44 for introducing liquid fuel in the system 10. Additional components as depicted in FIG. 1 include and exhaust outlet 46, a bypass valve 48 for liquid methanol exiting the anode 14, an air exhaust outlet 50, a water trap or collector 52, a water storage tank 54, a drain 56 to remove excess water from the system 10 and a pump 58 for recycling water.

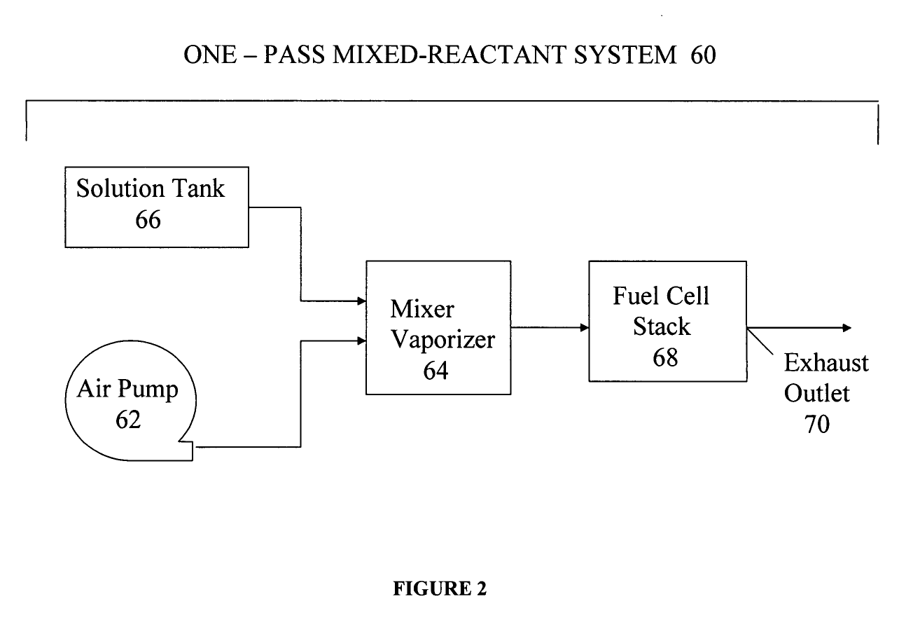

In a one-pass mixed reactant system 60 as depicted in FIG. 2 the incoming air, entering the system via an air pump 62, would pass through a mixer or vaporizer 64 where liquid fuel from a solution tank 66 is atomized into the air; the resulting flow is fed directly into the fuel cell stack 68. Any un-reacted fuel is exhausted through a fuel cell stack exhaust outlet 70 resulting in a system with low fuel efficiency.

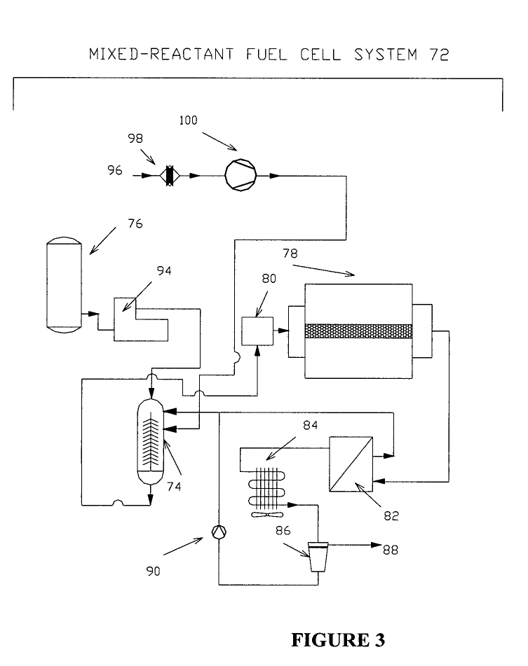

In a mixed-reactant fuel cell system 72 as depicted in FIG. 3 the incoming air would pass through a mixer 74 where the liquid neat methanol from neat methanol tank 76 and liquid methanol/water solution recovered from the stack exhaust are injected, atomized or sprayed into the air; the resulting flow is fed directly into the fuel cell stack 78 or brought to a gaseous state by passing through a vaporizer 80 and fed into the fuel cell stack 78. The stack exhaust goes into a gas/liquid separator 82 and the separated gaseous phase is passed through a radiator/condenser 84 where the methanol/water vapor is condensed and the condensate is collected 86, combined with the liquid collected from the stack exhaust and injected, atomized or sprayed into the incoming fresh air. The mixed-reactant fuel cell system 72 as depicted in FIG. 3 also includes an exhaust outlet 88, a pump 90 for recycling methanol, a methanol metering pump 94, an air inlet 96, an air filter 98, and an air pump 100 for introducing oxidant into the system 72. The means of unused fuel recovery in a mixed-reactant fuel cell system has a simpler configuration as compared to a direct methanol system because only one radiator/condenser is required to condense methanol/water vapor present in the unitary flow passing through the fuel cell stack. Nevertheless the volume and weight of the radiator/condenser and associated equipment: fans, condensate pump, etc. is a serious obstacle to building a compact, lightweight fuel cell system.

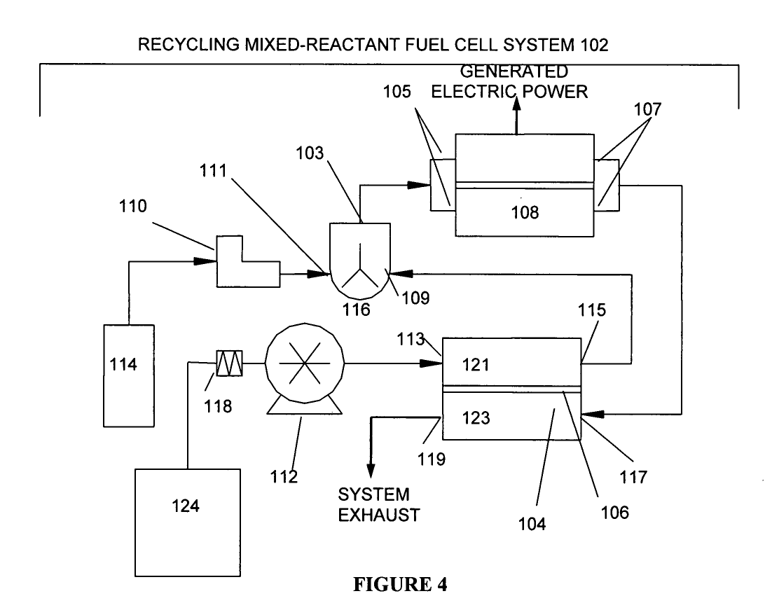

The present invention overcomes deficiencies incurred with prior fuel cell systems and is a modified mixed-reactant fuel cell system 102 with vapor recovery as depicted in FIG. 4 where the incoming oxidant initially passes through a membrane vapor exchange module 104 on one side of the vapor exchange membrane 106; the stream from the fuel cell stack exhaust outlet 107 flows through the same vapor exchange module 104 on the other side of the vapor exchange membrane 106. The methanol and water vapor contained in the stack exhaust stream are transferred to the incoming air due to the partial pressure differences between the two flow streams to the incoming air. The adjustment of methanol concentration in the flow entering the fuel cell stack 108 is achieved by injecting liquid neat methanol via a metering pump 110 downstream of the vapor exchange module 104 and upstream of the stack inlet 105.

The system 102 according to the invention referred to herein as a “recycling mixed-reactant fuel cell system” or as a “mixed-reactant fuel cell system with vapor recovery” (these terms are used interchangeably throughout the application) comprises at least the following components as depicted in FIG. 4: fuel cell stack 108, mass/enthalpy exchange module (such as a membrane vapor exchange module 104), oxidant pump 112 or other active or passive air delivery means, neat methanol or methanol solution or other appropriate liquid fuel storage 114 and means of metering or injecting fuel 110 from the storage 114 into the incoming reactant flow stream. Other potential components may include a mixer or atomizer 116 for faster evaporation and better distribution of fuel injected into the incoming flow, additional storages for water or methanol/water solutions and means for its delivery, oxidant filters 118 and fuel filters and liquid concentration sensors. The system may also include, but is not limited to, a power conversion system, system controllers and safety sensors.

The fuel cell system 102 of the invention is based on a mixed-reactant fuel cell that has a significantly simplified balance of plant due to a methanol/water recovery system based on mass/enthalpy exchange between the reactant flow exiting the fuel cell stack and flow entering the fuel cell stack. A representative apparatus in which such exchange can be achieved is a membrane vapor exchange device.

The process can be implemented if the re-circulating flow in the system is a two-phase liquid-gas flow or a one phase gas-vapor flow. In the first case heat loss will occur in the vapor exchange module due to liquid phase evaporation during the transfer process. That can make maintaining the stack operational temperature unsustainable without an external heat source. The required condition for heat balance sustainability of this process is maintaining of the recirculating flow in the system in gaseous or close to gaseous state. The mass transfer through the membrane then occurs without phase change and, consequently, without significant heat loss.

To assure the gas-vapor condition of the re-circulating methanol/water flow in the system the concentration of methanol in the flow should be high enough that the flow would be in gas-vapor phase at temperatures close to stack operational temperature.

The method of operation of the recycling mixed-reactant fuel cell system 102 is initiated by pumping or injecting via a metering pump 110 and oxidant pump 112, liquid fuel from storage unit 114, such as methanol (hydrogen source) and oxidant from oxidant source 124, such as air (oxygen source) into a mixer 116 or atomizer where the liquid fuel is intermixed or vaporized resulting in a mixed-reactant fuel. The mixed-reactant fuel exits the mixer 116 at outlet 103 and enters the fuel cell stack 108 through inlet 105 where it contacts the anode(s) and cathode(s) (not shown) of the fuel cell stack 108 producing an electric potential difference between the anode and cathode allowing for electric power generation. Fuel cell stack 108 exhaust containing un-reacted methanol, water and heat exits the fuel cell stack 108 at outlet 107, and then enters the vapor exchange module 104 at inlet 117. At the same time, oxidant from oxidant source 124, such as air, is pumped into the vapor exchange module 104 through inlet 113. The fuel cell stack 108 exhaust and oxidant are separated in the vapor exchange module 104 by a vapor exchange membrane 106. Un-reacted fuel (methanol), water and heat from the fuel cell stack 108 exhaust is transferred through the membrane 106 to the dry air or other oxidant, which results in recycled mixed-reactant fuel. Any remaining fuel cell stack exhaust exits the vapor exchange module 104 through outlet 119 while the recycled mixed-reactant fuel exits the vapor exchange module 104 at outlet 115 and then enters the mixer 116 at inlet 109. In order to readjust the concentration of methanol in the recycled mixed-reactant fuel to that of the initial mixed reactant fuel, fresh liquid fuel from storage tank 114 is pumped into a mixer 116 at inlet 111, or introduced directly into the flowing stream of recycled mixed reactant fuel, to mix with the recycled mixed-reactant fuel resulting in reconstituted mixed-reactant fuel. The reconstituted mixed-reactant fuel is introduced into the fuel cell stack 108 to continue the cycle and generate electrochemical power.

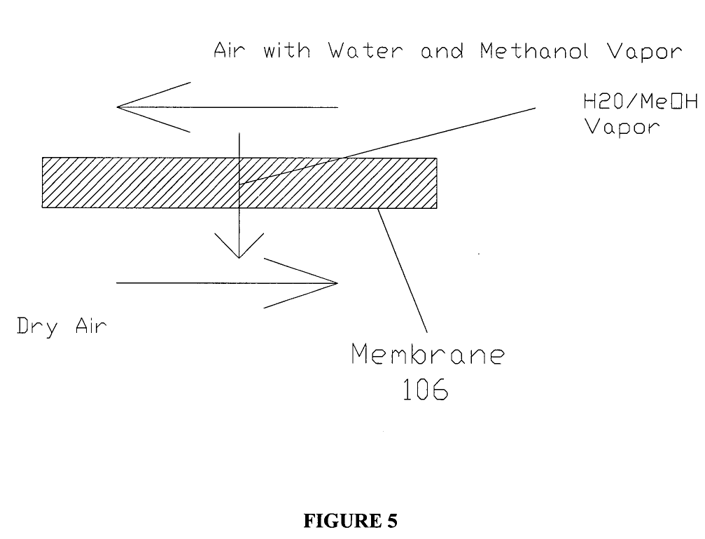

A system example is provided in the schematic diagram presented on FIG. 4. This example is not provided as a limitation to the operation of the fuel cell system 102, but merely as an example of its operation. The mass/enthalpy exchange module 104 that transfers methanol, water and heat from the mixed-reactant stream exiting the fuel cell stack 108 to the dry air or other oxidant entering the system. In this embodiment the mass/enthalpy exchange module 104 is engineered as a membrane vapor exchange module 104, whose principle of operation is depicted on FIG. 5. The partial pressure of methanol/water solution on the “wet” side 123 of the membrane 106 drives the methanol/water vapor through hydrophilic regions of the membrane 106 to the “dry” side 121, which contains oxidant. A non-porous membrane permeable to water and liquid fuel is used to prevent mixing of the “wet” and “dry” flows. One of possible membrane materials can be Nafion™ (DuPont, Wilmington, Del.). Hollow fiber materials are another example of membrane materials as well as any other material that is stable at operation conditions, has high permeability of water and methanol vapors and relatively impervious to permanent gases such as oxygen and nitrogen and has adequate mechanical strength.

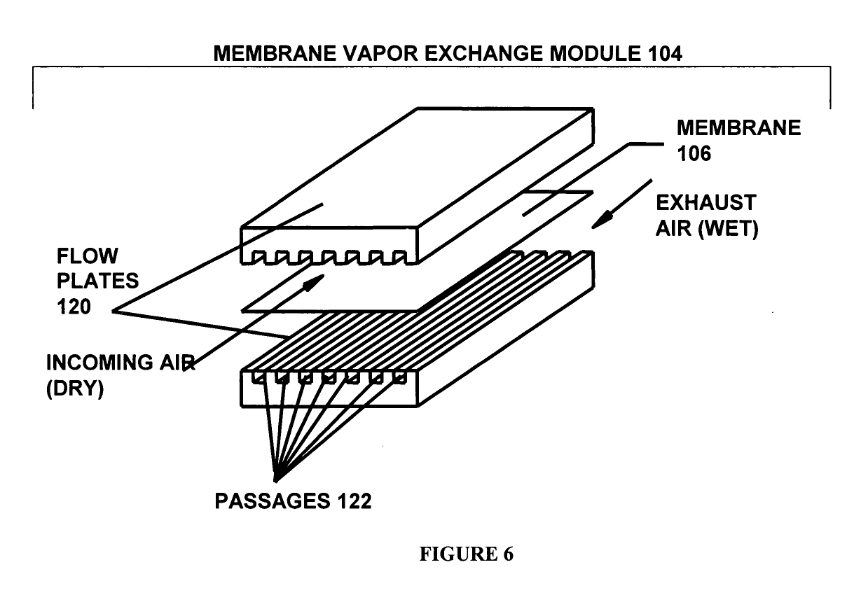

FIG. 6 shows schematically one design approach to the membrane vapor exchange module 104 where the vapor exchange membrane 106 is sandwiched between two flow plates 120 that have passages 122 for passing gaseous flows over the membrane. The flow passages 122 can be of various geometrically defined configurations such as, for example, curves, zigzags, serpentines, or straight channels or any other shape that effectively permits distribution of the gas phase over a large area of the membrane surface. The device comprises a plurality of stacked individual modules represented on FIG. 6 hydraulically connected in parallel. The “wet” flow (fuel cell stack exhaust) and “dry” flow (oxidant) usually are introduced in a “counter flow” configuration that allows for more complete heat and mass transfer from one flow to another. Another possible configuration would be the “tube and shell” configuration similar to fuel cell humidifiers and gas dryers produced by Perma-Pure Inc., Toms River, N.J., USA where the tubes are made from extruded Nafion™.

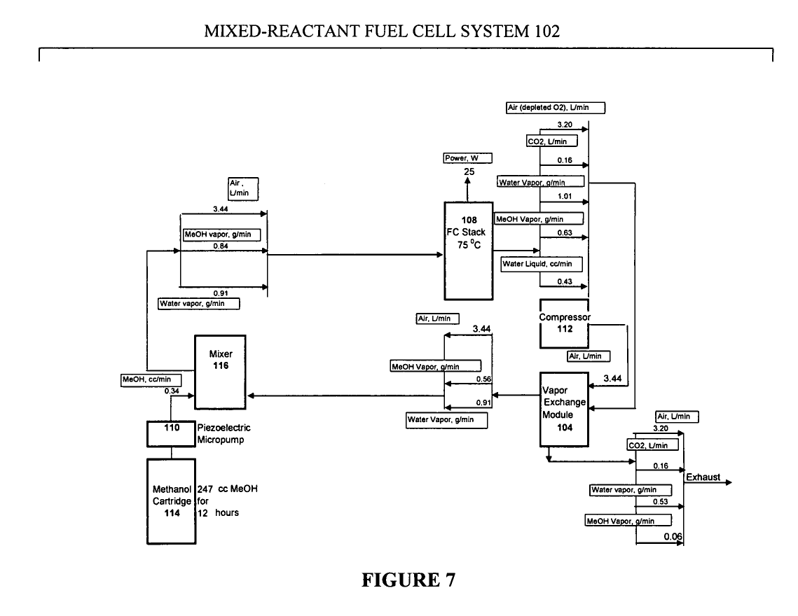

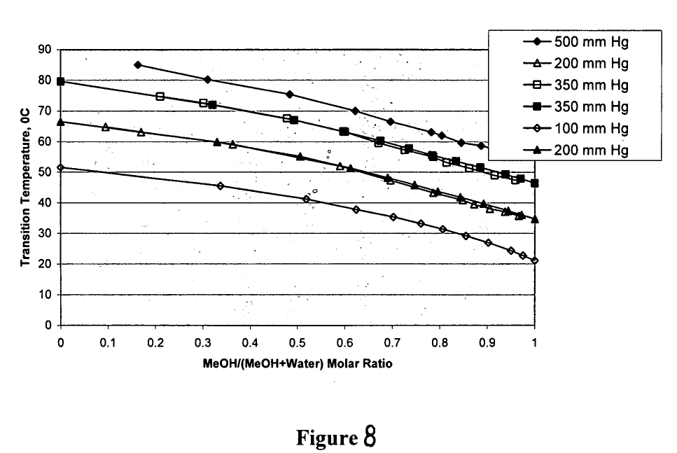

The system 102 as depicted in FIG. 7 is one example and in no way is a limitation to the system of this invention. Therefore, it should be realized that the specific dimensions, temperatures, amounts, etc. set forth therein are only exemplary and may vary within the scope of the invention. The system 102 as depicted in FIG. 7 is designed to produce no less then 15 W net of power with the fuel cell stack 108 producing 25 W of power. The active area of one cell is 20 cm² and the cell performance with use of specialized selective catalysts is assumed to be 0.05 A/cm² at cell voltage of 0.4 V. The number of cells in the stack is 63, but because of no need for flow plates and cell-to-cell separators the dimensions of the stack is of 2″×1.8″×2.2″ and the weight is below 50 g. FIG. 7 shows mass flows in the example system. In this system 3.44 SLPM (std Itr/min) of air are delivered by a micro-compressor-pump (Furgut, Germany) 112 to the vapor exchange module 104 made using 0.0005″ thick Nafion membrane and plastic frames with flow distributing elements. The dimensions of the vapor exchange module 104 are 2.5″×2″×2.4″ and the dimensions of the pump 112 are 3″ in length and 1.8″ in diameter. At nominal power output, the system requires 0.34 cc/min of neat methanol that is injected into the incoming air downstream of the vapor exchange module 104 by piezoelectric-micropump (thinXXS, Germany) 110. The flow exiting the stack 108 is directed to the vapor exchange module 104 where 70% of the water vapor that it contains and 90% of the methanol vapor are extracted and introduced into the incoming air stream. The incoming air is also heated close to the stack operating temperature by the exhaust air in the vapor exchange module 104. The operating temperature of the stack 108 is chosen to be close to 80° C. and is maintained at this level due to waste heat generated by the stack and appropriate thermal insulation. The content of methanol/water vapor in the flow entering the stack corresponds to 0.2-0.4 methanol to methanol plus water molar ratio, and as it is illustrated by FIG. 8 (Vapor-liquid equilibrium data collection/J. Gmehling, U. Onken, Dechema; Great Neck, N.Y.: Scholium International, [1977]-1984), the mixture will be in gas-vapor phase at this temperature without liquid phase present. The system operation will be at temperatures above or close to vapor/liquid (two phases) to vapor (one phase) transition temperatures throughout the system. The amount of neat methanol required for system operation at nominal power output for 12 hours is 247 cm³ of methanol. That and the sizing provided above for the main system components of the invention describes a compact, lightweight, efficient fuel cell system that can satisfy military and commercial customers in a number of applications.

Although the invention has been described with respect to various embodiments it should be realized that this invention also encompasses a wide variety of further and other embodiments and methods within the spirit and scope of the appended claims.

What is claimed is:

1. A fuel cell system comprising:
a mixed-reactant fuel cell stack;
a mass/enthalpy exchange module located downstream of the fuel cell stack and upstream of a fuel injection point and having at least one inlet for receiving a mixed reactant flow exiting the fuel cell stack and at least one inlet for receiving a flow of oxidant;
a means for delivering a flow of oxidant to the mass/enthalpy exchange module;
a reservoir for liquid fuel; and
a means for introducing the liquid fuel into the mixed-reactant flow at the fuel introduction point.

2. The system according to claim 1, wherein said mass/enthalpy exchange module recycles un-reacted fuel by transferring un-reacted fuel, water and heat exiting the fuel cell stack to the incoming oxidant stream.

3. The system according to claim 1, wherein said mass/enthalpy exchange module comprises a membrane vapor exchange module.

4. The system according to claim 3, wherein said membrane comprises at least one non-porous membrane.

5. The system according to claim 3, wherein said membrane comprises at least one hollow fiber material.

6. The system according to claims 4, wherein said non-porous membrane comprises a non-porous layer supported by a porous membrane substrate.

7. The system according to claim 1, wherein said liquid fuel is methanol.

8. The system according to claim 1, wherein said liquid fuel is a methanol/water solution.

9. The system according to claim 1, wherein said oxidant is air.

10. The system according to claim 1, wherein said oxidant is oxygen.

11. The system according to claim 3, wherein said membrane is positioned between two flow plates having passages for passing flow streams over the membrane.

12. The system according to claim 11, wherein said passages are selected from the group consisting of serpentine channels, straight channels, curved channels, and zigzag channels.

13. The system according to claim 1, wherein the fuel cell stack has an operational temperature which is maintained approximately at or above the temperature at which the mixed-reactant stream entering the stack is a single, gaseous phase.

14. The system according to claim 1, further comprising a fuel and oxidant mixer upstream of the fuel cell stack.

15. The system according to claim 1, further comprising a fuel atomizer upstream of the fuel cell stack.

16. The system according to claim 1, further comprising additional liquid fuel storage reservoirs; additional means for delivery of liquids; oxidant and fuel filters; and liquid fuel concentration sensors.

17. The system according to claim 1, further comprising a power conversion system; system controllers; and safety and process conditions sensors.

18. A method of recycling mixed-reactant fuel comprising:
passing an oxidant flow stream through a mass/enthalpy exchange module;
passing a mixed-reactant fuel cell stack exhaust flow stream through the mass/enthalpy exchange module;
transferring un-reacted fuel, water and heat in the fuel cell stack exhaust flow stream to the oxidant flow steam; and
producing recycled mixed-reactant fuel therefrom.

19. The method of claim 18, wherein said mass/enthalpy exchange module comprises a membrane vapor exchange module.

20. The method according to claim 19, wherein said membrane comprises at least one non-porous membrane.

21. The method according to claim 19, wherein said membrane comprises at least one hollow fiber material.

22. The method according to claim 20, wherein said non-porous membrane comprises a non-porous layer supported by a porous membrane substrate.

23. The method according to claim 18, wherein said fuel is methanol.

24. The method according to claim 18, wherein said fuel is a methanol/water solution.

25. The method according to claim 18, wherein said oxidant is air.

26. The method according to claim 18, wherein said oxidant is oxygen.

27. A method of generating electrochemical power comprising:
adding liquid fuel to recycled mixed-reactant fuel to produce reconstituted mixed-reactant fuel;
passing the reconstituted mixed-reactant fuel through a mixed-reactant fuel cell stack; and
generating electrochemical energy therefrom.

28. The method according to claim 27, wherein said recycled mixed-reactant fuel is produced by:
passing an oxidant flow stream through a mass/enthalpy exchange module;
passing a mixed-reactant fuel cell stack exhaust flow stream through the mass/enthalpy exchange module;
transferring un-reacted fuel, water and heat in the fuel cell stack exhaust flow stream to the oxidant flow steam; and
producing recycled mixed-reactant fuel therefrom
